(19) United States
(12) Patent Application Publication
(10) Pub. No.: US 2013/0088724 A1
(43) Pub. Date: Apr. 11, 2013

(54) METHOD AND APPARATUS FOR THE INSPECTION OF SANDWICH STRUCTURES USING LASER-INDUCED RESONANT FREQUENCIES

(71) Applicants: Marc Dubois, Keller, TX (US); Thomas E. Drake, JR., Fort Worth, TX (US)

(72) Inventors: Marc Dubois, Keller, TX (US); Thomas E. Drake, JR., Fort Worth, TX (US)

(21) Appl. No.: 13/649,015

(22) Filed: Oct. 10, 2012

Related U.S. Application Data
(60) Provisional application No. 61/545,995, filed on Oct. 11, 2011.

(51) Int. Cl. G01B 9/02

(52) U.S. Cl. 356/519; 356/450

(57) ABSTRACT

A method for inspecting a sandwich structure may comprise determining a reference frequency, directing first and second laser beams onto the structure, collecting reflected light, processing it using an interferometer, acquiring a time-dependent signal for a predetermined duration greater than a period corresponding to the reference frequency, processing the time-dependent signal to produce a frequency-dependent signal, and comparing characteristics of the processed frequency-dependent signal to the reference frequency. A laser-ultrasonic apparatus configured to inspect sandwich structures may comprise first and second laser beams configured to generate acoustic energy in and illuminate a sandwich structure, respectively, an interferometer configured to receive reflected light and generate a time-dependent signal, detection electronics configured to process the time-dependent signal to produce a time-dependent electrical signal, and one or more processing units configured to convert the time-dependent electrical signal into a frequency-dependent signal and to compare characteristics thereof to characteristics of a reference frequency-dependent signal.

### CROSS-REFERENCE TO RELATED APPLICATIONS

This application claims priority to U.S. Provisional Patent Application No. 61/545,995, entitled METHOD AND APPARATUS FOR THE INSPECTION OF COMPOSITE SANDWICH STRUCTURES USING LASER-INDUCED RESONANT FREQUENCIES, filed Oct. 11, 2011, which is hereby incorporated by reference for all purposes.

### FIELD OF THE DISCLOSURE

The present invention generally relates to the non-destructive inspection of sandwich structures used in the aeronautic industry using laser-ultrasonics and in particular by measuring the resonant frequency of the structure and comparing it to the characteristic resonant frequency of a defect-free reference structure.

### BACKGROUND

Sandwich structures are widely used in the aeronautic industry because they are lightweight and structurally strong. For example, some sandwich structures are made of two thin skins of fiber-reinforced polymer-matrix composite laminates, attached on both sides of a lightweight but relatively thick core, usually an open-cell honeycomb structure. This type of structure is illustrated in FIG. 1A. Other, less common, configurations are possible where multiple core materials are bonded to one or more intermediate laminate layers made of various materials. In general, any structure made of any number of alternating layers of significantly different materials or sub-structures can be considered as a sandwich structure.

Sandwich structures require nondestructive inspection after manufacturing to detect the presence of defects before being put into service. Typical defects found are disbonds of the skin from the core, damaged core, porosity in the skin, delamination in the skin, and foreign material in either the skin or the core among others.

The traditional technique to inspect sandwich structures is ultrasonic through-transmission. This technique typically consists of using two piezoelectric transducers, one emitter and one receiver. The ultrasonic wave is sent from the emitter into the sandwich structure via a water coupling path which is frequently a column of water. The high-frequency (above 500 kHz) ultrasonic waves propagate in the structure and are detected on the other side of the structure by the receiver, using another water path (column). A generic representation of the through-transmission technique is shown in FIG. 1B. The emitter and receiver are moved along the part to inspect large areas of the part.

Even though the through-transmission technique is widely used in the aeronautic industry, this technique suffers from several limitations. A first limitation is the requirement to have access to both sides of the part. The part must be designed to give access to both sides for the non-destructive inspection, limiting therefore the flexibility of the designers. A second limitation is the use of water for ultrasonic coupling. The water might infiltrate the honeycomb core, preventing adequate ultrasonic detection, and possibly damaging the core. A third limitation is due to the nature of the signal measured by the receiver. The receiver measures only the amplitude of the signal. This measurement only tells if a defect is present or not, and gives no information about the type of defect. A fourth limitation is due to the reflection and refraction properties of the ultrasonic waves at the water/structure interfaces. To maintain a proper signal transmission between the emitter and receiver, these two devices must be precisely aligned relative to the normal of the structure surface. Any misalignment will result in a loss of signal that could be interpreted as a defect. For sandwich structures having complex shapes, this limitation results in slow inspection rates due to the time required to execute contour-following programming operations and the generally slow nature of complex contour following scanning manipulators. Slow inspection rates correspond to decreased manufacturing efficiency due to slow throughput, increased capital equipment costs, increased labor costs, and an overall decrease in productivity.

As an alternative to the water coupled through transmission technique, air-coupled techniques have been developed using frequencies typically below 500 kHz. Air coupled ultrasound does eliminate the negative effects of water but still suffers from many of the other limitations of water coupled ultrasound identified previously: two-sided access, complex scanning paths for contoured parts, and slow scanning speeds.

Another ultrasonic inspection technique that can be applied is called pulse-echo. In this case, the ultrasonic waves are launched into the sample from one side and detected from the same side. This technique is especially useful for the inspection of simple fiber-reinforced polymer-matrix composite laminates. The pulse-echo technique measures the time delay of the ultrasonic wave reflected by a defect, providing time information in addition to the amplitude information. Unfortunately, because of the nature of its structure, only very little ultrasonic energy is propagated by the honeycomb core. The pulse-echo technique requires the ultrasonic waves to propagate twice in the honeycomb core, resulting in a signal that is attenuated following the square of the attenuation that would be observed in an equivalent through-transmission technique. Even though it provides more information and requires only single-side access to the structure, the pulse-echo technique is almost never used for the inspection of sandwich structures because of the very weak signal that can be measured and the resulting low probability of detecting defects.

A variation of the pulse-echo technique for the inspection of fiber-reinforced polymer-matrix composite laminates is the laser-ultrasonic technique, shown in FIG. 2. This technique was demonstrated to be cost-effective for the inspection of complex-shape fiber-reinforced polymer-matrix composite laminates in the aeronautic industry. This technique eliminates the requirement of water-coupling and of alignment of the transducer with the normal of the sample surfaces. However, similar to traditional pulse-echo techniques, the standard laser-ultrasonic technique cannot assess the full integrity of sandwich structures because of the weak signal due to the high attenuation of the ultrasonic waves propagating in the honeycomb core. Pulse-echo technique can be used to measure the integrity of the skins of the sandwich structures but this approach requires the inspection of both sides of the structure and another technique (like X-ray for example) must be used to evaluate the integrity of the honeycomb. This approach is time-consuming and expensive, and therefore does not constitute a sustainable approach for high production rates.

Additionally, there has been some development in the use of optical shearography methods to inspect sandwich structures. Shearography is an optical method to measure surface deformation. This technique may detect some types of sandwich structure defects but requires specialized test methods to induce deformations in the surface of the structure through secondary stimuli such as heat, vacuum or acoustic vibrations. This added complexity requires extensive validation of testing techniques which is often unique to a particular part configuration. This method is less common in industry, compared to through-transmission ultrasound, partially due to the complexity of developing robust inspection methodologies and validation procedures.

### SUMMARY

Embodiments of the present disclosure generally provide an apparatus and method for assessing the structural integrity of structures using laser-ultrasonics.

In an aspect, the present disclosure is directed to a method for assessing the structural integrity of a sandwich structure that may comprise the steps of determining a reference frequency, directing a first laser beam onto the sandwich structure wherein the first laser beam is absorbed on at least one surface of the sandwich structure thereby producing acoustic energy in the sandwich structure, illuminating an area of the surface of the sandwich structure with a second laser beam, collecting light of the second laser beam reflected from the illuminated surface, processing the collected light using an interferometer, acquiring a time-dependent signal from the interferometer for a predetermined duration greater than a period corresponding to the reference frequency, processing the time-dependent signal to produce a frequency-dependent signal, and comparing characteristics of the processed frequency-dependent signal to the reference frequency.

In an embodiment, an amplitude of the frequency-dependent signal may be used to determine the presence of defects in the sandwich structure. In another embodiment, a frequency value of a peak in the frequency-dependent signal may be used to determine the presence of defects in the sandwich structure. In yet another embodiment, a frequency value of at least one peak of the frequency-dependent signal and the reference frequency may be used to determine the type of defects in the sandwich structure.

In an embodiment, the interferometer is a confocal Fabry-Perot. In another embodiment, the first laser beam is generated by a pulsed CO₂ laser. In various embodiments, the second laser comprises a seed laser amplified by an optical amplifier. In an embodiment, the optical amplifier comprises a fiber amplifier. In another embodiment, the optical amplifier comprises a diode-pumped slab or rod. In yet another embodiment, the optical amplifier comprises a flash-lamp pumped slab or rod.

In an embodiment, a two-dimension optical scanner is used to direct the first and second laser beams onto the sandwich structure.

In another aspect, the present disclosure is directed to a laser-ultrasonic apparatus configured to inspect sandwich structures that may comprise a first laser source and a second laser source configured to generate a first laser beam and a second laser beam, the first laser beam and the second laser beam configured to be directed to the surface of a sandwich structure, wherein the first laser beam generates acoustic energy in the sandwich structure and the second laser beam illuminates the sandwich structure, an interferometer configured to receive light of the second laser beam reflected by the structure and to generate a time-dependent signal in response to the reflected light, detection electronics configured to process the time-dependent signal from the interferometer to produce a time-dependent electrical signal, and one or more processing units configured to convert the time-dependent electrical signal into a frequency-dependent signal and to compare characteristics, of the frequency-dependent signal to characteristics of a reference frequency-dependent signal.

In an embodiment, a duration for which the second laser is directed onto the surface of the sandwich structure may be changed according to the type of structure to be inspected. In another embodiment, the apparatus may be configured for measuring low-frequency frequency-dependent signals and high-frequency pulse-echo time-dependent signals. In yet another embodiment, at least two separate detection electronics having different sensitivity responses as a function of frequency may process in parallel the time-dependent signal from the interferometer to produce at least two time-dependent electrical signals having different frequency bandwidths.

In various embodiments, electronic detection bandwidth may be changed according to the type of structure to be inspected. In an embodiment, timing of the first laser being directed onto the sandwich structure relative to the second laser being directed onto the sandwich structure may be changed according to the type of structure to be inspected. In another embodiment, timing of starting to digitize the time-dependent electrical signal relative to the second laser being directed onto the sandwich structure may be changed according to the type of structure to be inspected. In yet another embodiment, duration of the acquired time-dependent signal may be changed according to the type of structure to be inspected.

In an embodiment, the interferometer may be a confocal Fabry-Perot. In another embodiment, the first laser beam may be generated by a pulsed CO₂ laser. In yet another embodiment, the second laser may comprise a seed laser amplified by an optical amplifier. In still another embodiment, the apparatus may comprise a two-dimension optical scanner for directing the first and second laser beams onto the sandwich structure.

### BRIEF DESCRIPTION OF THE DRAWINGS

For a more complete understanding of the features, example embodiments and possible advantages of the present invention, reference is now made to the detailed description of the invention along with the accompanying figures and in which:

FIG. 1A (prior art) depicts a representative sandwich structure.

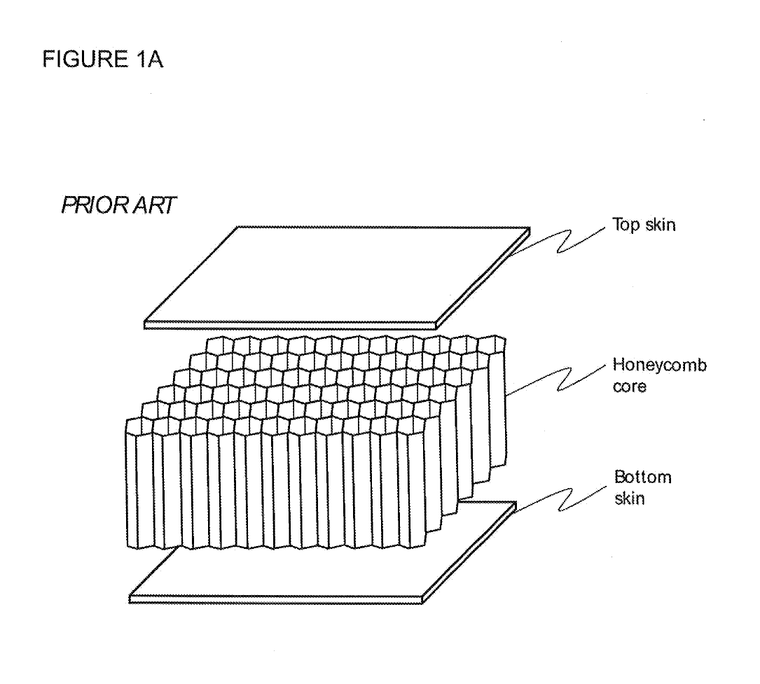

FIG. 1B (prior art) schematically depicts a through transmission measurement of a sandwich structure.

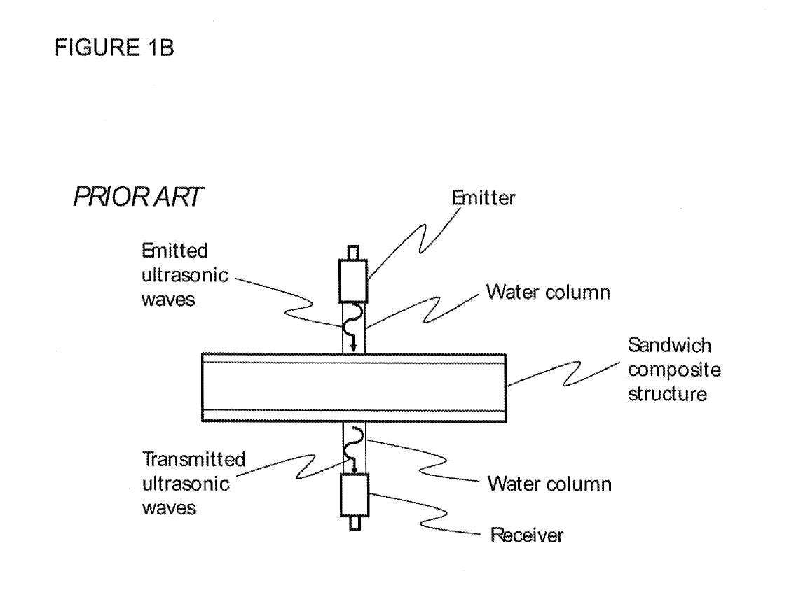

FIG. 2 (prior art) schematically depicts a laser-ultrasonic measurement system for the inspection of fiber-reinforced polymer-matrix composite laminates.

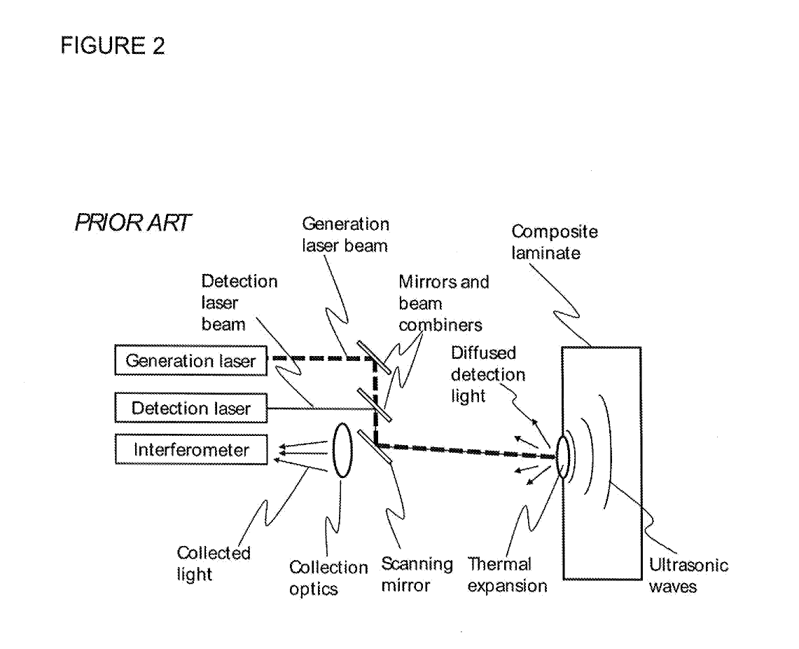

FIG. 3 schematically depicts the generation of acoustic waves by laser in a sandwich structure.

FIG. 4 depicts representative plots of the relative sensitivity of the interferometer and detection electronics of the signal measurement system.

FIG. 5 depicts representative plots of the measured signal in the frequency domain for a measurement point on a sandwich structure without defect.

FIG. 6 depicts a representative plot of the measured signal in the frequency domain for a measurement point on a sandwich structure with one type of defect.

FIG. 7 depicts a representative plot of the measured signal in the frequency domain for a measurement point on a sandwich structure with another type of defect.

FIG. 8 depicts possible steps for performing evaluation of the integrity of a sandwich structure.

### DETAILED DESCRIPTION

Embodiments of the present disclosure generally provide a method and apparatus for the inspection of sandwich structures using laser-induced resonant frequencies. In various embodiments, a laser-ultrasonic inspection system may be configured to inspect composite laminates using pulse-echo ultrasonic techniques and sandwich structures using acoustic resonance techniques. In various embodiments, a laser-ultrasonic inspection system may be configured to excite a resonant acoustic frequency in a sandwich structure, and measure and evaluate resulting acoustic displacement to determine if the structure is defective. In various embodiments, additional information about the type of defect may be obtained by evaluating the shift between measured acoustic frequency and the characteristic acoustic resonant frequency of a defect-free sandwich structure.

Generally speaking, embodiments of a technique for the evaluation of the integrity of a sandwich structure may comprise the use of a pulsed laser to excite a large range of acoustic frequencies in the top surface of the structure. Some of the acoustic energy will excite a resonant frequency of the sandwich structure. The mechanical displacement at the surface is measured using another laser that may be coupled to an interferometer in an embodiment. The frequencies of the acoustic displacements are evaluated. If the measured acoustic resonant frequencies differ from the characteristic resonant frequency, or if the amplitudes of the acoustic displacements at the characteristic frequency are too low, the sandwich structure may be defective. Additional information about the type of the defect can be obtained by evaluating the shift between the measured acoustic resonant frequency and the characteristic resonant frequency of a defect-free sandwich structure.

The present invention provides a technique that may reduce the costs of inspection of sandwich structures and composite laminates. Currently, composites laminates are inspected by pulse-echo systems while sandwich structures are typically inspected by through-transmission systems. Two types of systems are therefore necessary when both laminates and sandwich structures are used in manufacturing. Sometimes, both laminates and sandwich structures are present in the same part, requiring additional manipulations to inspect some areas of the part with a pulse-echo system and some other areas of the part with a through-transmission system.

Laser-ultrasonic pulse-echo systems may be preferable over conventional water-based pulse-echo systems for the inspection of composite laminates. The ability to inspect complex part with very little preparation and setup, very simple programming, and no exposure to water couplant may be desirable. It may also be desirable to not have to own and operate two different inspection systems (water-based pulse-echo and through-transmission systems) for the inspection of both composite laminates and sandwich structures.

In various embodiments, the process begins by determining a reference frequency. Typically, the reference frequency may be the characteristic resonant frequency of the defect-free sandwich structure to be tested, though one skilled in the art will recognize that the reference frequency may comprise other properties. In various embodiments, the reference frequency may be determined by analyzing data from experiments, by the experience of the operator, by mathematical modeling, or by a combination of those techniques. For example, an operator could use the experimental system and method describe hereafter to acquire data from a reference sandwich structure known to be free of defects and use the measured resonant frequency peak as the reference frequency. Another example would be to use mathematical models based on physical and mechanical characteristics of the sandwich structure to be tested to determine the reference resonant frequency. Still another example would be to use experience acquired with the measurements of several sandwich structures and determine that a certain category of sandwich structures have a characteristic resonant frequency, Fc, equal to Fc=K/t, where K is a constant determined by experience, and t is the thickness of the sandwich structure. For example, for a value of K=500 kHz-mm, a sandwich structure of a thickness of 25 mm would have a characteristic frequency equal to Fc=500 kHz-mm/25 mm=20 kHz.

A pulsed laser may be used to generate broadband ultrasonic waves in one skin of a sandwich structure with sufficient energy to excite the characteristic resonant frequency of the structure. In an embodiment, the optical wavelength of the laser may be selected to be absorbed at the correct optical penetration depth in order to generate a broadband acoustic waves of sufficient amplitude in the range of acoustic frequencies of interest. In an embodiment, the laser pulse duration may also be short enough to provide good acoustic signal generation. Acoustic waves generated in polymer-matrix composites, by the thermal expansion due to the absorption of a laser pulse, may contain an extremely broad range of acoustic frequencies from a few kHz to several Mhz. This assumes an appropriate laser pulse is selected with sufficiently short time duration and of the proper wavelength for adequate optical penetration into the polymer-matrix top surface. Additionally, a metallic sandwich structure could also be evaluated with this method if the inspected surface is covered by a polymer layer, like paint for example, for efficient laser ultrasound generation. The optical wavelength of the CO2 laser (10.6 μm) with a pulse duration of approximately 100 ns or less was found to be an efficient generator of broadband acoustic signals in most fiber-reinforced polymer-matrix composite laminates.

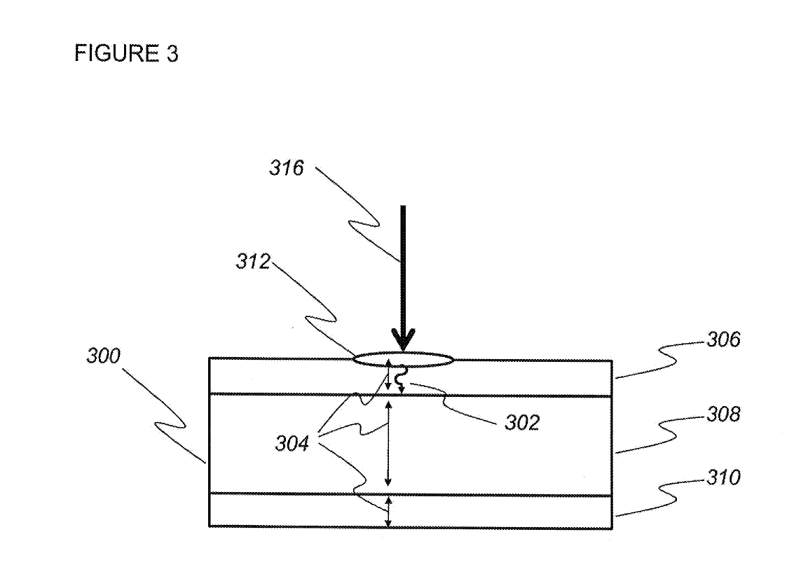

FIG. 3 schematically depicts a process of acoustic wave generation and resonance at the characteristic frequency. In an embodiment, a pulsed laser beam 316 may be directed onto sandwich structure 300, and may be absorbed at the surface of a top skin 306. Optical absorption of the pulsed laser beam 316 may result in localized thermal expansion depicted as item 312 for illustrative purposes. Localized thermal expansion may create broadband acoustic waves 302 that may propagate through top skin 306 and transmitted to a honeycomb core 308.

Honeycomb core 308 may attenuate acoustic frequencies of the incoming broadband acoustic waves 302. In some cases, honeycomb core 308 may attenuate most acoustic frequencies except for frequencies close to the characteristic frequency. Honeycomb core 308 may then start oscillating at its resonant frequency. This resonant frequency may depend strongly on the thickness of the honeycomb core, but also on the natures of the honeycomb core and of characteristics of the skins. Skins 306 and 310 may experience mechanical displacements 304 that may correspond to oscillations of honeycomb core 308. In an embodiment, this may occur because top and bottom skins 306, 310 may be much thinner than honeycomb core 308, and the resonant oscillation frequency may have a corresponding wavelength much longer than the thickness of skins 306, 310. The resonant frequency of sandwich structure 300 is a representation of the combination of the physical and mechanical properties of the two skins 306, 310 and of honeycomb core 308. A defect inside honeycomb core 308 or at the interface between the honeycomb core 308 and one of the skins 306, 310, or within one of the skins 306, 310 may affect the measured resonant frequency of the sandwich structure 300, possibly even preventing any resonance oscillations.

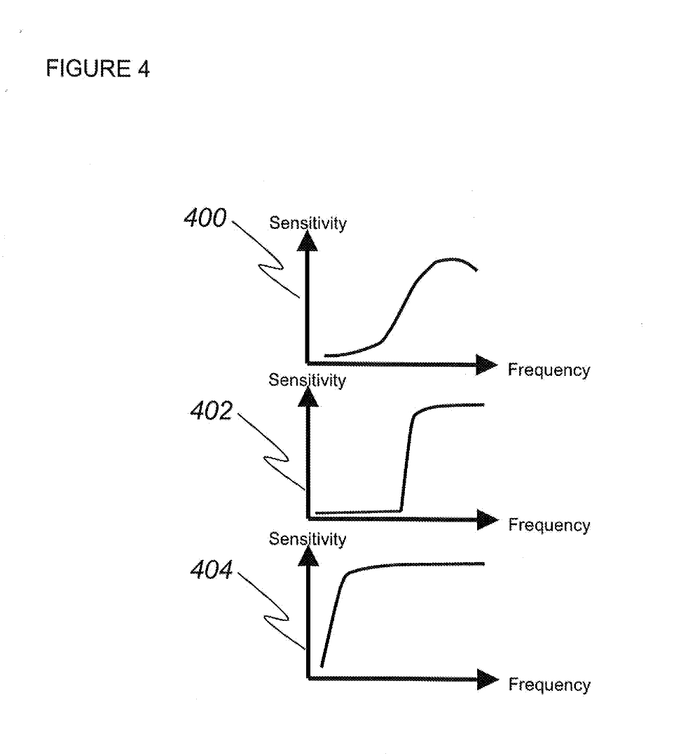

Referring now to FIG. 4, plots 400, 402, and 404 depict representative relative sensitivity of interferometer and detection electronics of a signal measurement system. After acoustic waves 302 have been generated by the absorption of the laser pulse 316, mechanical displacements 304 may be measured using a detection laser and an interferometer. In an embodiment, the interferometer may be coupled with the detection laser. In various embodiments, the detection laser pulse duration, the interferometer and its detection electronics may be adapted to measure the characteristic frequencies of sandwich structures which are typically between a few kHz to a few hundred kHz. Typical interferometers are designed to be as sensitive as possible to the ultrasonic displacements in the few MHz range. For pulse-echo measurement, this maximum sensitivity is important because the ultrasonic displacements may be extremely small. Previously, laser-based pulse-echo systems were either too insensitive or otherwise incapable of capturing and analyzing these low frequencies because they are of no use in standard pulse-echo laminate testing. Plot 400 depicts a typical relative sensitivity plot of an interferometer like a confocal Fabry-Perot with the sensitivity peak corresponding to the 1 to 5 MHz range, for example. The relative sensitivity corresponding to the low-frequency range of typical characteristic frequencies (10 to 100 kHz for example) of sandwich structures can be ten times lower than at the sensitivity peak. However, because of the lower frequencies, the mechanical displacement can easily be ten times larger than those in the MHz range. The detectability of defects in sandwich structures can therefore be excellent using an interferometer designed for pulse-echo ultrasonic measurements in composite laminates with a relative sensitivity curve similar to that depicted in plot 400. However, to improve detectability of the defects, detector electronics may be modified to improve the signal in the range of the typical characteristic acoustic frequencies of sandwich structures. In general, the electronics response for interferometers used for composite laminate inspection may be attenuated below the frequency range of interest for sandwich structures, as illustrated in plot 402 depicting the relative sensitivity of detection electronics. For example, the electronics for composite laminate inspection may be typically designed to attenuate signals below 0.5 MHz to eliminate possible low frequency noise. The detection electronics of a laser-ultrasonic system for composite laminate inspection may be modified to have a response looking like relative sensitivity plot 404. In an embodiment, the laser-ultrasonic system may therefore be configured to switch from detection electronics having relative sensitivity response corresponding to that shown in plot 402, to detection electronics having relative sensitivity response corresponding to that shown in plot 404 when switching from laminate inspection to sandwich structure inspection. In another embodiment, electronics may be used having a relative sensitivity similar to that shown in plot 404, and digital processing may be employed to eliminate undesirable low frequency signal when inspecting composite laminates. In yet another embodiment, the laser-ultrasonic system might be equipped with two parallel detection electronic processing, one having a relative sensitivity response corresponding to that shown in plot 402 and the other one with a relative sensitivity response corresponding to the one shown in plot 404. In this latter embodiment, high-frequency pulse-echo time-dependent signals for inspection of composite laminates and low-frequency frequency-dependent signal for the inspection of sandwich structures can be acquired simultaneously. Notice that plots 402 and 404 have the shapes of the response plots of typical high-pass frequency filters. In another embodiment not illustrated here, plots 402 and 404 would look like typical response plots of band-pass frequency filters where the sensitivity responses decrease at frequencies above a certain response peak or plateau.

Embodiments of the present disclosure may require acquisition of a signal for a duration that would preferably be at least a few cycles of the characteristic frequency of the sandwich structure. For example, for a characteristic acoustic frequency of 20 kHz, the cycle time may be 1/20 kHz=50 μs. In an embodiment, acquisition duration may be larger than 100 μs, as a minimum of 2 cycles or periods may be desirable for proper detection. For ultrasonic inspection of composite laminates, acquisition durations may be related to the largest thickness to be inspected. For example, for a 50 mm thick material, the acquisition time should be at least 2×50 mm/V where V is the ultrasonic velocity in fiber-reinforced polymer-matrix materials with typical values around 3 mm/μs. The total acquisition time for a pulse-echo measurement in laminate composites typically may be on the order of 2×50/3=33 μs. Therefore, for the inspection of sandwich structures, the signal acquisition durations are usually significantly increased compared to the signal acquisition time for laminate composites.

In laser-ultrasonic inspection, the duration of the detection laser pulse may be equal or larger than the duration of the signal acquisition. In an embodiment, the generation laser pulse and the start of the signal digitizing may be properly timed so that the ultrasonic signal and its acquisition occur entirely during the detection laser pulse. When switching a laser-ultrasonic system for composite laminate inspection to inspection of sandwich structure, the detection laser pulse duration and timing, the timing of the generation laser pulse, and the start of the signal digitizing may be adapted to increase the signal acquisition duration. For example, in a typical measurement cycle of a composite laminate, the detection laser may have a pulse cycle of 300 μs of which approximately 200 μs may be used. The generation laser may be fired with a pulse duration of approximately 1 μs when approximately 50 μs remain in the detection laser pulse. Data may be collected during the final 50 μs of the detection pulse. The measurement point may moved and the process repeated. For measurement of a sandwich structure, the detection laser cycle may remain the same. However, the generation laser may be fired when approximately 200 μs remain in the detection pulse. Data may be collected for approximately 200 μs, and may thereby provide data sufficient for obtaining the frequency signal described herein.

In various embodiments, the detection laser may be configured to have adjustable pulse duration. In one such embodiment, detection laser may comprise a seed laser amplified by a fiber amplifier. In various embodiments, other types of detection lasers may be used. In an embodiment, detection laser may comprise a seed laser amplified by an amplifier comprised of slab or rods pumped by diodes or flash-lamps. It should be recognized that a variety of detection lasers may be used, and the present disclosure should not be limited to just those described herein.

Once the signal has been acquired with the appropriate timings and durations, the signal may be transformed from the time domain to the frequency domain. This transformation may be easily accomplished using well-established digital Fast-Fourier transform techniques among others. The amplitude of the acoustic displacement at the characteristic resonant frequency of the inspected sandwich structure provides information about the importance of the defect and the shift between the characteristic resonant frequency and the measured resonant frequency peak provides information about the nature of the defect.

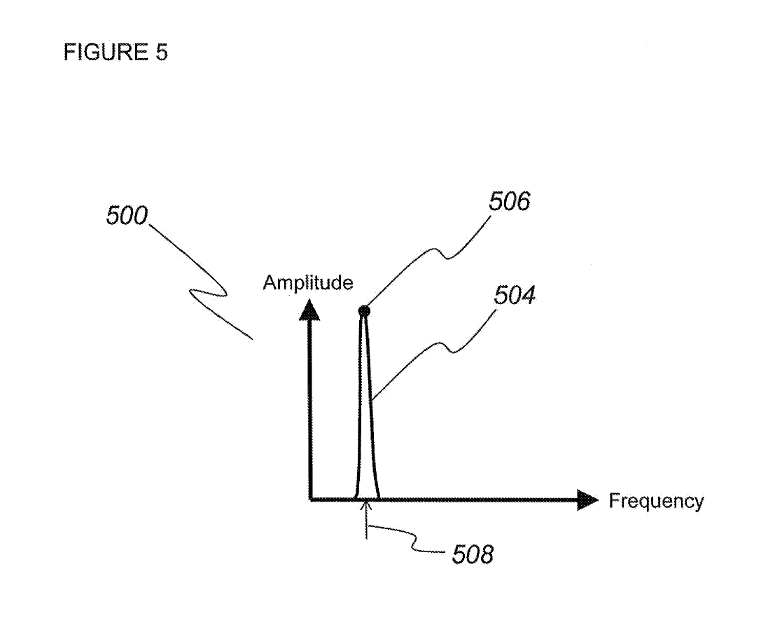

Referring now to FIG. 5, plot 500 depicts a typical representation of signal amplitude as a function of frequency as obtained from a healthy sandwich structure. The signal as a function of frequency may be analyzed by evaluating the amplitude of the signal corresponding to the characteristic resonant frequency of a defect-free sandwich structure and at the frequency value of the signal peak. The characteristic resonant frequency of the defect-free sandwich structure is indicated by 508. In that case, the measured resonant peak, illustrated by the signal peak 504, has amplitude indicated by 506 and a frequency value corresponding exactly to the characteristic resonant frequency 508 of a defect-free sandwich structure.

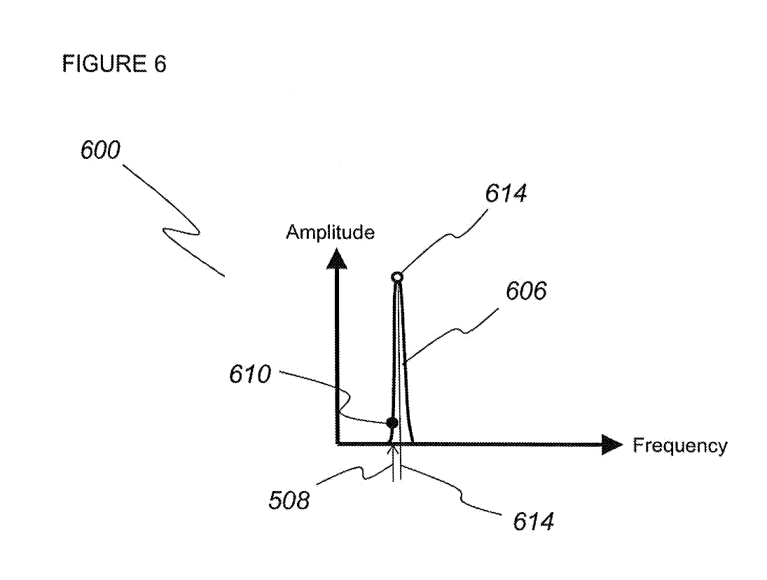

Referring now to FIG. 6, plot 600 depicts a typical representation of signal amplitude as a function of frequency as btained from a sandwich structure with a well-defined defect like a disbond or a defect in one of the skins. In an embodiment, the structure with the defect may be characterized by a measured resonant peak, illustrated by signal peak 606, having low amplitude 610 at the characteristic resonant frequency 508 of a defect-free sandwich structure. In addition, the signal peak 606 may have a peak 614 at a frequency value 614 different from the characteristic resonant frequency 508. The low amplitude value 610 at the characteristic resonant frequency may be an indicator of the presence of a defect at the measurement point. The difference between the characteristic resonant frequency 508 and the peak frequency value 614 may be an indicator of the type of defect

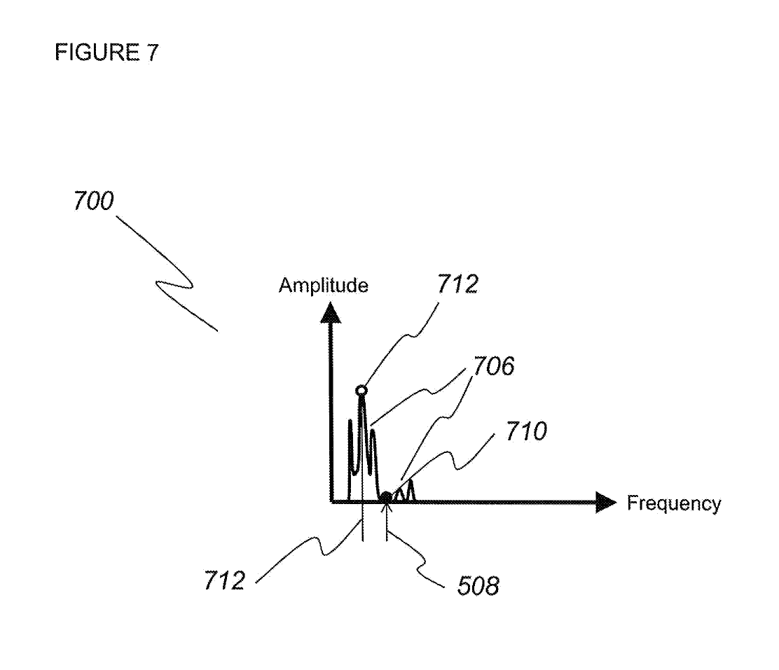

Referring now to FIG. 7, plot 700 depicts a typical curve representation of signal amplitude as a function of frequency for a sandwich structure with an undefined defect. The defect may be characterized by the absence of a well-defined measured resonant peak, as illustrated by the many peaks in the measured signal 706 with low amplitude 710 at the characteristic resonant frequency 508 of a defect-free sandwich structure. In addition, the signal 706 may have a maximum peak 712 at a frequency value 712 significantly different from the characteristic resonant frequency 508. The low amplitude value 710 at the characteristic resonant frequency may be an indicator of the presence of a defect at the measurement point. The difference between the characteristic resonant frequency 508 and the peak frequency value 712 may be an indicator of the type of defect.

The signal amplitude values at the characteristic resonant frequency and the difference between the signal peak frequency and the characteristic resonant frequency can be plotted in separate graphs as a function of position of the measurement point. These graphs may correspond to conventional ultrasonic C-scan representations and would help an operator locate the presence and position of defects. The change of position of the measurement point may be accomplished by different means including, but not limited to, moving the part or moving the laser beams using one or more movable mirrors.

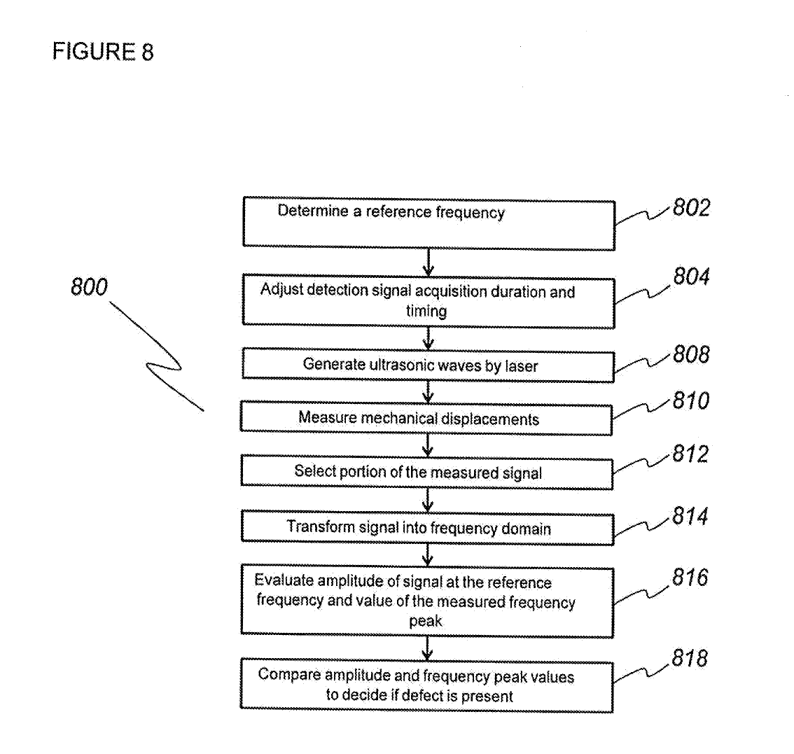

Referring now to FIG. 8, in an embodiment, process 800 may comprise any suitable combination of steps 802-818 and others required for the inspection of a sandwich structure according to the present disclosure. Step 802 may comprise determining a reference frequency. In an embodiment, the reference frequency may comprise the characteristic resonant frequency of the defect-free sandwich structure to be tested. In step 804, acquisition parameters such as the detection pulse timing, acquisition duration, timing of the generation laser pulse, and digitizing start may be adjusted to optimize the signal of the resonant frequency of the sandwich structure to be inspected. It should be recognized that steps 802 and 804 do not need to be performed for each measurement point if the sandwich structure remains essentially the same from one measurement point to the other. In step 808, a generation laser pulse may be produced that is absorbed by one of the skins of sandwich structure resulting in acoustic waves propagating in the structure. Step 810 may comprise measurement of the mechanical displacements resulting from the generated acoustic waves. This measurement may be done using a detection laser beam coupled to an interferometer. In an embodiment, the detection laser beam can overlap the generation laser beam on one of the skins in the case of a laser scanning system or could be located on the opposite skin. Step 812 may comprise selecting a portion of the acquired signal, or the full signal, for further processing. Step 812 might be necessary if some of the acquired signal occurs before the generation laser pulse or after the detection laser pulse is terminated, or if some feature of the signal, like the surface echo, would introduce noise in the signal after the transformation into the frequency domain. It should be recognized that step 812 may be performed for other reasons. In step 814, a selected portion of the signal may be transformed into the frequency domain according to well-established digital techniques. In step 816 the amplitude of the signal at the reference frequency and of the frequency value of the signal maximum peak may be evaluated. Those values, or a combination of those values such as the difference between the reference frequency and the frequency of the signal maximum peak, can then be plotted in graphs as a function of measurement position. In step 818 whether a defect is present at the measurement point may be determined based on the results of step 816. Step 818 may be accomplished after the signals were acquired and analyzed for all measurement points using a graphic representation of the results of step 816.

Larger samples can be analyzed using a scanner to inspect areas of composite laminates and sandwich structures by repeating the measurement steps above, other than the first two steps, and moving the place being measured between measurements.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for assessing the structural integrity of a sandwich structure, the method comprising:
determining a reference frequency;
directing a first laser beam onto the sandwich structure wherein the first laser beam is absorbed on at least one surface of the sandwich structure thereby producing acoustic energy in the sandwich structure;
illuminating an area of the surface of the sandwich structure with a second laser beam;
collecting light of the second laser beam reflected from the illuminated surface;
processing the collected light using an interferometer;
acquiring a time-dependent signal from the interferometer for a predetermined duration greater than a period corresponding to the reference frequency;
processing the time-dependent signal to produce a frequency-dependent signal; and
comparing characteristics of the processed frequency-dependent signal to the reference frequency.

2. The method of claim 1, wherein an amplitude of the frequency-dependent signal is used to determine the presence of defects in the sandwich structure.

3. The method of claim 1, wherein a frequency value of a peak of the frequency-dependent signal is used to determine the presence of defects in the sandwich structure.

4. The method of claim 1, wherein a frequency value of at least one peak of the frequency-dependent signal and the reference frequency are used to determine the type of defects in the sandwich structure.

5. The method of claim 1, wherein the interferometer is a confocal Fabry-Perot.

6. The method of claim 1, wherein the first laser beam is generated by a pulsed CO₂ laser.

7. The method of claim 1, wherein the second laser comprises a seed laser amplified by an optical amplifier.

8. The method of claim 7, wherein the optical amplifier comprises a fiber amplifier.

9. The method of claim 7, wherein the optical amplifier comprises a diode-pumped slab or rod.

10. The method of claim 7, wherein the optical amplifier comprises a flash-lamp pumped slab or rod.

11. The method of claim 1, wherein a two-dimension optical scanner is used to direct the first and second laser beams onto the sandwich structure.

12. A laser-ultrasonic apparatus configured to inspect sandwich structures comprising:
a first laser source and a second laser source configured to generate a first laser beam and a second laser beam, the first laser beam and the second laser beam configured to be directed to the surface of a sandwich structure, wherein the first laser beam generates acoustic energy in the sandwich structure and the second laser beam illuminates the sandwich structure.
an interferometer configured to receive light of the second laser beam reflected by the structure and to generate a time-dependent signal in response to the reflected light;
detection electronics configured to process the time-dependent signal from the interferometer to produce a time-dependent electrical signal; and
one or more processing units configured to convert the time-dependent electrical signal into a frequency-dependent signal and to compare characteristics of the frequency-dependent signal to characteristics of a reference frequency-dependent signal.

13. The apparatus of claim 12, wherein a duration for which the second laser is directed onto the surface of the sandwich structure is changed according to the type of structure to be inspected.

14. The apparatus of claim 12, being configured for measuring low-frequency frequency-dependent signals and high-frequency pulse-echo time-dependent signals.

15. The apparatus of claim 12, wherein at least two separate detection electronics having different sensitivity responses as a function of frequency process in parallel the time-dependent signal from the interferometer to produce at least two time-dependent electrical signals having different frequency bandwidths.

16. The apparatus of claim 12, wherein electronic detection bandwidth is changed according to the type of structure to be inspected.

17. The apparatus of claim 12, wherein timing of the first laser being directed onto the sandwich structure relative to the second laser being directed onto the sandwich structure is changed according to the type of structure to be inspected.

18. The apparatus of claim 12, wherein timing of starting to digitize the time-dependent electrical signal relative to the second laser being directed onto the sandwich structure is changed according to the type of structure to be inspected.

19. The apparatus of claim 12, wherein duration of the acquired time-dependent signal is changed according to the type of structure to be inspected.

20. The apparatus of claim 12, wherein the interferometer is a confocal Fabry-Perot.

21. The apparatus of claim 12, wherein the first laser beam is generated by a pulsed CO₂ laser.

22. The apparatus of claim 12, wherein the second laser comprises a seed laser amplified by an optical amplifier.

23. The apparatus of claim 12, comprising a two-dimension optical scanner for directing the first and second laser beams onto the sandwich structure.
